(19) United States
(12) Patent Application Publication
(10) Pub. No.: US 2013/0224510 A1
(43) Pub. Date: Aug. 29, 2013

(54) SYSTEM INCLUDING THERMAL INTERFACE MATERIAL

(71) Applicants: Tao Deng, Clifton Park, NY (US); Yogen Vishwas Utturkar, Niskayuna, NY (US); Binoy Milan Shah, Schenectady, NY (US); Charles Franklin Wolfe, JR., Albany, NY (US); Pramod Chamarthy, Niskayuna, NY (US)

(72) Inventors: Tao Deng, Clifton Park, NY (US); Yogen Vishwas Utturkar, Niskayuna, NY (US); Binoy Milan Shah, Schenectady, NY (US); Charles Franklin Wolfe, JR., Albany, NY (US); Pramod Chamarthy, Niskayuna, NY (US)

(73) Assignee: GENERAL ELECTRIC COMPANY, Schenectady, NY (US)

(21) Appl. No.: 13/408,305

(22) Filed: Feb. 29, 2012

(51) Int. Cl. B32B 15/01; B29C 65/48

(52) U.S. Cl. 428/576; 156/498

(57) ABSTRACT

A system for heat transfer along with the method of preparation of the same is described. System includes a first surface, a second surface, and an interface material. The interface material is disposed between the first and second surfaces such that it is solid at an assembling temperature and liquid at an operating temperature. The first surface of the system is configured to adhere to the solid and liquid thermal interface material, and the second surface is configured to adhere to the liquid thermal interface material and be detachable from the solid interface material. The method of preparation of the system includes disposing the first surface, an interface material, and a second surface, heating the interface material to above its melting point and then cooling to a temperature below melting point to detach and remove the second surface from the interface material.

### BACKGROUND

This invention relates generally to a system including an interface element and particularly to thermal interface material and method of using the thermal interface material.

Electronic circuits are limited by the amount of heat dissipated, which is a surrogate for the maximum junction temperature an electronic system is allowed to experience. Heat transfer between two surfaces may happen in different ways. The surfaces are typically used as mating surfaces for better thermal conductivity. Thermal interface materials (TIM) play a key role in the thermal management of electronic systems by providing a path of low thermal resistance between the heat-generating devices and the heat spreader/sink at the interface surfaces. The efficient flow of heat may be impeded if there are any air gaps or voids. Conventional thermal interface materials are often positioned at the interface to fill the gaps or voids between the two surfaces so that the thermal resistance is lowered, thereby allowing the heat to flow away efficiently from the hotter surface to the cooler surface.

A second function that a TIM performs is to reduce stresses resulting from coefficient of thermal expansion (CTE) mismatch between the heat-source and heat-sink during temperature cycling. Typical TIM solutions include adhesives, greases, gels, phase change materials, pads, and thermal pastes. Most traditional TIMs consist of a polymer matrix, such as an epoxy or silicone resin, and thermally conductive fillers such as boron nitride, alumina, aluminum, zinc oxide, and silver. However, these traditional TIM systems have either high thermal resistance or low compliance.

The liquid metal matrix thermal paste is described as being used for cooling high power dissipation components in conjunction with a conventional fluid cooling system. The paste may be cleaned from surfaces by using metal wool containing tin or copper filaments.

However, cleaning the surfaces to remove TIM at each dismantling may become cumbersome. Further, in some cases, the TIMs may not be re-usable, and need to be discarded after each use and insert a new TIM. Therefore, an ideal TIM is desired to have optimal thermal and mechanical properties and to be compatible with the present standard electronics assembly processes. Desirable properties of TIM include low bulk and interface thermal resistances, sufficient compliance to absorb thermally induced strain without causing early fatigue failure, sufficient conformability to accommodate surface roughness of the surfaces, processability at relatively low temperatures, robustness during storage and operation, reworkability and reusability.

### BRIEF DESCRIPTION

Briefly, in one embodiment, a system is provided. The system includes a first surface, a second surface, and an interface material. The interface material is disposed between the first and second surfaces. The interface material disposed is such that the interface material is solid at an assembling temperature and liquid at an operating temperature. The first surface of the system is configured to adhere to the solid and liquid thermal interface material, and the second surface is configured to adhere to the liquid thermal interface material and be detachable from the solid interface material.

In one embodiment, a system is provided. The system includes a first aluminum surface, a second aluminum surface, and a thermal interface material. The first aluminum surface includes a wetting layer with pores on the surface and the second aluminum surface is smooth. The thermal interface material includes indium in a range from about 50 mole % to about 52 mole %, bismuth in a range from about 31 mole % to about 33 mole %, and tin in a range from about 15 mole % to about 17 mole %, and disposed between the first and second surfaces. The thermal interface material is in a solid form at an assembling temperature and in the liquid form at an operating temperature, a part of the thermal interface material is configured to be interlocked in the wetting layer in the solid and liquid form, and the second aluminum surface is configured to be detachable from the solid thermal interface material.

In one embodiment, a method is disclosed. The method includes disposing a first surface comprising a wetting layer with pores, disposing an interface material over the first surface, disposing a second surface over the interface material, heating the interface material to a temperature above melting point of the interface material to interlock a part of the interface material within the pores of the wetting layer and to adhere to the first and second surfaces and then cooling the interface material to a temperature below melting point of the interface material to detach the second surface from the interface material, and removing the second surface from the interface material.

### DRAWINGS

These and other features, aspects, and advantages of the present invention will become better understood when the following detailed description is read with reference to the accompanying drawings in which like characters represent like parts throughout the drawings, wherein:

FIG. 1 illustrates arrangement of a first surface, second surface, and interface material, according to an embodiment of the invention;

FIG. 2 illustrates arrangement of a first surface, second surface, and interface material, according to an embodiment of the invention;

FIG. 3 illustrates arrangement of a first surface and interface material as per an example according to one embodiment of the invention;

FIG. 4 graphically compares thermal resistances of different thermal interface materials in a system;

FIG. 5 illustrates arrangement of an electronic assembly as per an example according to one embodiment of the invention; and

FIG. 6 compares the thermal resistivity of a baseline with the thermal resistance over multiple runs of assembly/dis-assembly of an electronic system, according to one embodiment of the invention.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following specification and the claims that follow, the singular forms “a”, “an” and “the” include plural referents unless the context clearly dictates otherwise.

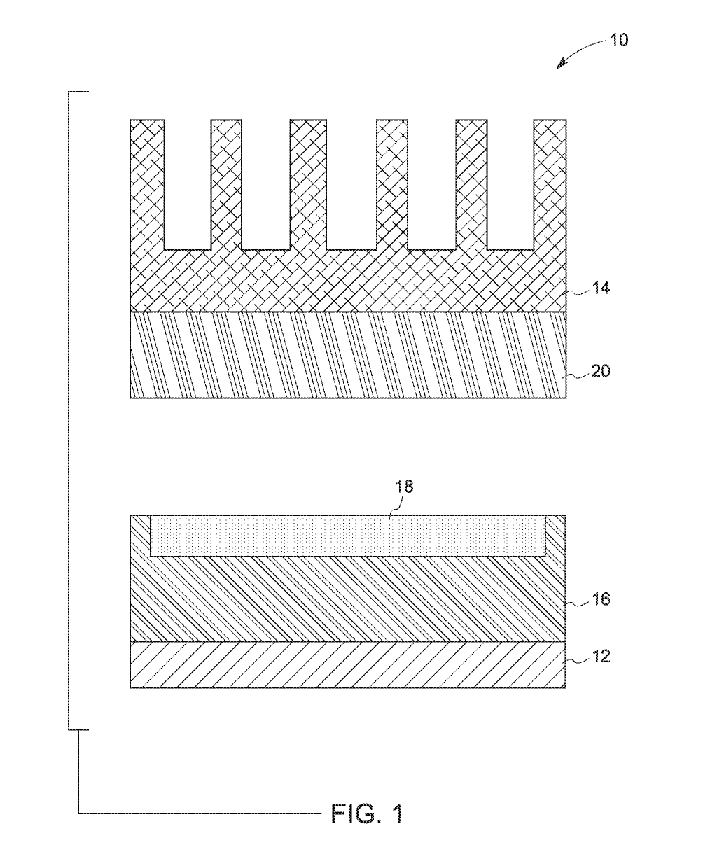

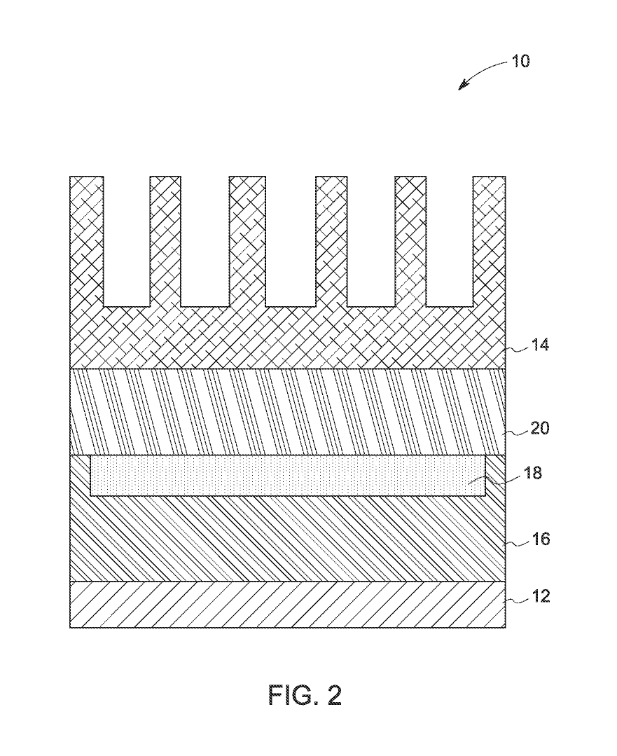

Systems having heat-sources and heat-sinks benefit from effective methods for transferring the heat from the heat-source to heat-sink. In one embodiment of the present invention, a system 10 is presented that may efficiently transfer the heat from heat-source 12 to heat-sink 14 as shown in FIG. 1 and FIG. 2. FIG. 1 illustrates the system 10 when the interface material 18 is detached from the second surface 20, and the FIG. 1 illustrates the system 10 when the interface material 18 is attached to the second surface 20. As used herein, “detached” means that the two parts (interface material 18 and the second surface 20) are not in thermal contact with each other. Similarly, “attached” means the thermal contact between the two parts. The system 10 includes an interface material 18 disposed between two surfaces identified as first surface 16 and second surface 20. The surfaces used herein may be elemental metals, alloys, or compounds including one or more metallic elements. In one embodiment, the surfaces include oxides, nitrides, or carbides of a metal or metal alloy. In one embodiment, the first and second surfaces include similar materials. In one embodiment, the first surface 16 is coupled to a heat-source 12 and the second surface 20 is a coupled to a heat-sink 14. In another embodiment, the first surface 16 is coupled to a heat-sink 14 and the second surface 20 is coupled to a heat-source 12. As used herein the “coupling” means arranging the system parts, thereby providing a path for thermal conductivity.

In one embodiment, the first surface 16 is the heat source 12 or integrated onto the heat source 12, and the second surface 20 is the heat-sink 14 or integrated onto the heat-sink 14. In another embodiment, the first surface 16 is the heat-sink 14 or integrated onto heat-sink 14, and the second surface 20 is the heat source 12 or integrated onto heat source 12. As used herein, “integrated onto” means that the two parts involved are in efficient thermal contact with each other.

In one embodiment, the surfaces are configured such that the first and second surfaces are amenable to be separated from each other very often. For example, in one embodiment, the first and second surfaces are separated from each other and coupled again at least about 100 times in an operating cycle. In one embodiment, different first surfaces are used along with one second surface. In one embodiment, different second surfaces are used along with one first surface.

In one embodiment, the interface material 18 used herein is a thermal interface material. The thermal interface material 18 transfers the heat generated from a heat-source 12 to a heat-sink 14. Therefore, depending on the surfaces that coupled to heat-source and heat-sinks, the thermal interface material 18 used herein transfers the heat between the two surfaces. In one embodiment, the thermal conductivity of the thermal interface material 18 is greater than about 1 W/mK. In one embodiment, the thermal conductivity of the thermal interface material 18 is in the range from about 5 W/mK to about 200 W/mK. In one embodiment, the thermal conductivity of the interface material 18 is the range from about 5 W/mK to about 25/mK. In another embodiment, the thermal conductivity of the interface material 18 is in the range from about 100 W/mK to about 125/mK.

The interface material 18 used herein is such that the material is solid at an assembling temperature and liquid at an operating temperature. As used herein the “assembling temperature” is the temperature at which the combination of first surface 16 and the interface material 18 is brought into contact with the second surface 20. In one embodiment, the assembling temperature is less than about 85° C. In one embodiment, the assembling temperature is in between about 0° C. and about 50° C. In one embodiment, the assembling temperature is in between about 15° C. and about 25° C.

As used herein the “operating temperature” is the temperature at which the system including the first and second surfaces and the interface material 18 is performing an assigned operation. In one embodiment, in the beginning of this operation stage, the temperature of the heat-source 12 increases, the heat is transferred to one of the surface coupled to the heat-source 12, and further is transferred through the interface material 18 to the surface coupled to the heat-sink 14. During this stage, the temperature of the interface material 18 increases and the material melts. Therefore, in one embodiment, when the operation of the system stabilizes, the heat transfer from the surface coupled to the heat-source 12 and the surface coupled to the heat-sink 14 happens through the liquid interface material 18. In one embodiment, the operating temperature is greater than about 30° C. In one embodiment, the operating temperature is in between about 50° C. and about 125° C. In one embodiment, the operating temperature is greater than the assembling temperature.

As described earlier, the interface material 18 is solid at the assembling temperature and liquid at the operating temperature of the system. When the interface material 18 is at the assembling temperature, the first surface 16 is configured to adhere to the interface material 18 and the second surface 20 is configured to be detachable from the interface material 18. Thus, at the assembling temperature and when the interface material 18 is in the solid form, the interface material 18 is attached to the first surface 16 and is detachable from the second surface 20. As used herein, “detachable” means that the two parts (in this embodiment, the interface material 18 and the second surface 20) are amenable for easy separation from each other without leaving behind greater than 5% of any residual material of any one part in another during separation. In one embodiment, the second surface 20 is modified to be detachable from the interface material 18. In one embodiment, the second surface 20 is made smooth to decrease the adherence of the interface material 18 to the second surface 20. In one embodiment, the roughness of the second surface 20 is less than about 25 μm. In one embodiment, the roughness of the second surface 20 is less than about 5 μm. In one embodiment, the second surface 20 includes a non-wetting composition for the interface material 18. As used herein the “non-wetting composition for the interface material 18” means that the composition does not have any chemical or physical affinity to the interface material 18. The second surface 20 may include aluminum, aluminum composite, copper, or copper composite. In one embodiment, the second surface 20 may be coated with oxides, nickel, chrome, or black anodized coating. In one embodiment, the second surface 20 is an aluminum surface.

The first surface 16 may be configured to adhere to the interface material 18 at both the assembling temperature and the operating temperature. In one embodiment, the interface material 18 is disposed over the first surface 16 and caused to melt and adhere to the first surface 16 even before using the system for the intended operation. The first surface 16 may be configured to adhere or in other words, rendered “adhereable” to the interface material 18 in different ways. As used herein the term “adhereable” means the two parts (in this embodiment, the interface material 18 and the first surface 16) are not amenable for separation from each other without breaking any one part in another during separation.

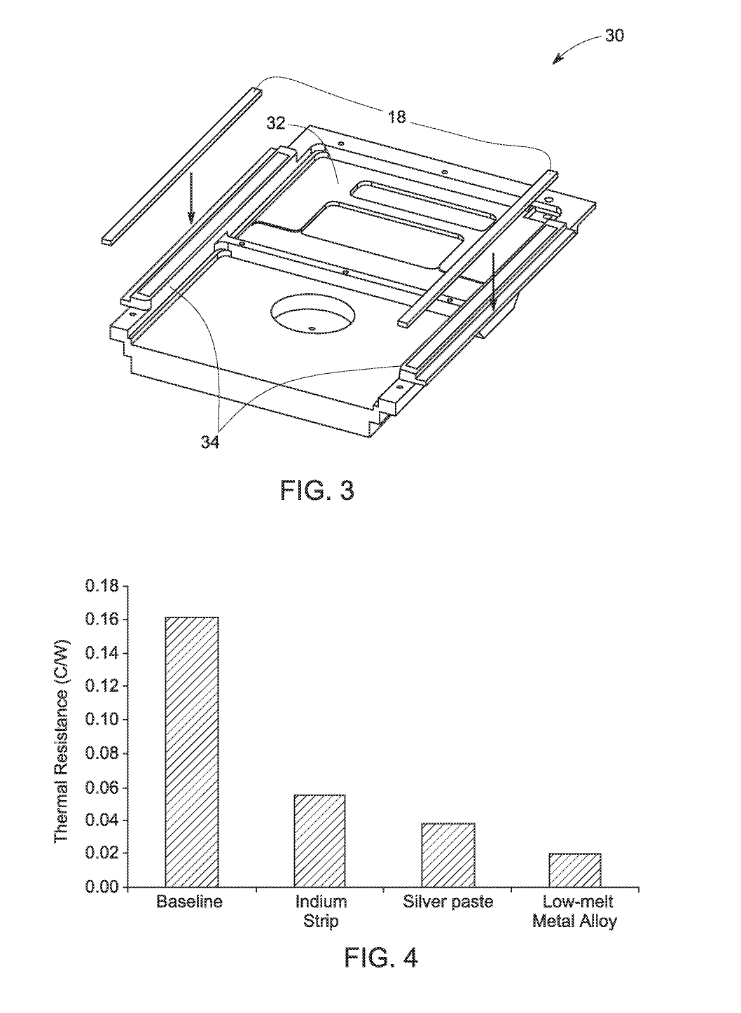

The first surface 16, the second surface 20, and the interface material 18 may have different shapes and designs. In one embodiment, the first surface 16 has a cup-shaped design, thereby holding the interface material 18 while it is liquid. In one embodiment, the first surface has a channel type structure. In one embodiment, the first surface 16 is in the shape of a rectangular dip 34 in a base structure 32 as shown in FIG. 3. In one embodiment, the second surface 20 is in the form of a rectangular strip projection to come into contact with the dip 34 (not shown).

The adherence of the interface material 18 may vary based on the characteristics of the first and second surfaces such as for example, surface roughness and the material composition of the surface. In one embodiment, the first surface 16 is an aluminum surface. In one embodiment, the first surface has a surface roughness greater than about 5 μm. In one embodiment, the surface roughness is in the range from about 8 μm to about 25 μm. In one embodiment, the first surface 16 includes a wetting layer (not shown). The wetting layer may have an affinity to attract or retain the interface material 18. The wetting layer may be a modified surface or a coating over the surface. Addition of a surface modification material to increase the affinity to attract or retain the interface material 18 to the first surface 16 is an example of the surface modification of the first surface 16. The wetting layer may include further non-metal components or composites as compared to the first surface 16. In one embodiment, the wetting layer includes a coating. In one embodiment, the coating includes a material selected from the group consisting of aluminum oxide, nickel, chromium, gold, platinum, and titanium. In one embodiment, the coating includes a polymer. In another embodiment, the coating is free of any polymeric material.

In one embodiment, the wetting layer includes grooves, channels, posts, pillars, and/or pores. In one embodiment, at least a part of the thermal interface material 18 is interlocked in the wetting layer at the assembling temperature (in solid form) and at the operating temperatures (in liquid form). As used herein, the “liquid is interlocked in the wetting layer” means that the liquid is partially trapped in the wetting layer and does not completely drain out from the wetting layer without applying an excessive external force to the liquid or the surface. The design of the first surface 16 as a porous structure such as meshes and wicks helps to retain the liquid on the first surface 16.

In one embodiment, the first and the second surfaces are configured to adhere to the interface material 18 at the operating temperature. The liquid interface material 18 is in contact with both the first and second surfaces at the operating temperature. In one embodiment, during operation, the first surface 16 is placed below the interface material 18 and the second surface 20 is placed above the interface material 18. In one embodiment, the interface material 18 is subjected to a pressure at the operating temperature. In one embodiment, the combination of first surface 16, interface, and the second surface 20 may be subjected to a certain pressure at operating temperature. In one embodiment, the pressure applied may be transferred to the interface material 18 through the second surface 20. The pressure applied to the combination of the first surface 16, interface material 18, and the second surface 20 may assist in increasing wetting of the second surface 20 by the liquid interface material 18 at the operating temperature.

In one embodiment, the interface material 18 is subjected to a pressure greater than about 100 kPa. In one embodiment, the interface material 18 is subjected to a pressure in the range from about 135 kPa (20 psi) to about 3450 kPa (500 psi) at the operating temperature. In one embodiment, weight of the second surface 20 is be used to create the pressure to be applied on the interface material 18. In one embodiment, the pressure is applied by a mechanical locking system such as a wedgelock, or nut and bolt system.

In one embodiment, at the assembling temperature, the interface material 18 does not experience any pressure at the assembling temperature. Lack of applied pressure on the interface material 18 may help in the detachment of the interface material 18 from the second surface 20 at the assembling temperature.

In one embodiment, a method of assembling and a method of using the system are disclosed. The method of assembling includes disposing an interface material 18 in between the first surface 16 second surface 20 and heating. The first surface 16 may include a wetting layer with pores or grooves and the interface material 18 may be a thermally conducting low temperature melting alloy. The pores and grooves as used herein may be big enough to be penetrated and occupied by the liquid interface material. Heating the surface interface material 18 surface to a temperature above the melting point of the interface material 18 causes the interface material 18 to melt and closely contact to the first and second surfaces.

The liquid interface material 18 may penetrate into the pores or grooves of the first surface 16, if the pores or grooves are present on the first surface 16. If the second surface 20 is smooth, the liquid interface material 18 may be in contact with the second surface 20, without penetrating the second surface 20. The system may be cooled at this stage to a temperature below the melting point of the interface material 18 to obtain an interlocked interface material 18 on the surface of the first surface 16, that is detachable from the smooth second surface 20, as the solid interface material 18 is not adhered to the second surface 20.

The system assembled as described above may be used for the intended operation in different ways. As the thermal interface layer is solid at room temperature, it is easier to handle and install without compromising the thermal communication between the first and second surfaces during operation, further allowing for a reusable interface. As the interface material 18 is only interlocked with the first surface 16 in one embodiment, the second surface 20 may be detached from the interface material 18 when the system is not in operation and can be brought into contact with the interface material 18 again during assembling and operated to pass thermal energy to or from the interface material 18 during the operation of the system. As the second surface 20 is detachable from the interface material 18 after operation, the second surface 20 once used may be easily replaced by any other material required for the intended operation. Further as the detachment of the second surface 20 from the interface material 18 during the solid form of the interface material 18 does not remove significant interface material 18 from the system, the change of second surface 20 does not necessitate any further addition of the interface material 18 to the system. Therefore, multiple attachment/detachments of the second surface 20 of the system are feasible in the lifetime of the system. In one embodiment, the second surface 20 is amenable to be removed from and reinserted to the system at least about 100 times in the life time of the system. In one embodiment, the second surface 20 is removed and reinserted at least about 500 times in the life time of the system without losing any interface material 18. Further, the second surface 20 may be amenable to be changed multiple times during the life of the system without changing the first surface 16 or the interface material 18.

In one embodiment, the interface material 18 chosen for the system may be a low melting point material acting as a thermal interface between two surfaces. In one embodiment, the interface material 18 is a non-polymeric material. As used herein, the “non-polymeric” material does not include any polymer material. In one embodiment, the interface material 18 is a metal alloy. The metal alloy is chosen such that it is solid at the assembling temperature and liquid at operating temperature. Having the thermal interface material 18 in a solid form at room temperature is advantageous for easy handling and installation. However, at operating temperatures the metal alloy melts, forming an intimate thermal contact between the first and second surfaces. Depending on the thermal conductivity of the interface material 18, the thermal contact between the first and second surface 20s is generally good when the interface material 18 is in the liquid form. Further, the system and the design of interface material 18 and the surfaces ensure that the interface material 18 always adheres to one surface (here first surface 16) and not the other. Hence the embodiments of the invention provide a reusable interface between the interface material 18 and the second surface 20 thereby allowing the second surface 20 to be assembled and dis-assembled multiple times. In one embodiment, the interface material 18 includes indium. In one embodiment, the interface material 18 includes bismuth and tin. In one embodiment, the composition of the interface material 18 includes about 45 mole % to about 55 mole % of indium, about 28 mole % to about 38 mole % of bismuth, about 12 mole % to about 22 mole % of tin. Some examples of the interface material 18 are provided in the table 1 below. In an embodiment, the interface material 18 includes indium in the range from about 50 mole % to about 52 mole %, bismuth in the range from about 31 mole % to about 33 mole %, and tin in the range from about 15 mole % to about 17 mole %.

TABLE 1

| | Melting Temperature | |
|---|---|---|
| Alloy Name | (° C.) | Composition |
| INDALLOY 19 ® | 60 | 51.0-In, 32.5-Bi, 16.5-Sn |
| INDALLOY 162 ® | 72 | 66.3-In, 33.7-Bi, |
| INDALLOY 174 ® | 79 | 26.0-In, 57.0-Bi, 17.0-Sn |
| INDALLOY 27 ® | 81 | 29.7-In, 54.0-Bi, 16.3-Sn |
| INDALLOY 53 ® | 109 | 33.0-In, 67.0-Bi, |

In one embodiment, the interface material 18 is disposed as a layer in between the first surface 16 and the second surface 20. In one embodiment, a part of the interface material 18 layer is interlocked in the wetting layer of the first surface 16. In one embodiment, the thickness of the interface material 18 in between the first and second surfaces during operation is in the range from about 5 microns to about 1000 microns. As used herein the thickness is measured including the interlocked part of the interface material 18 layer on the surface of the first surface 16.

### EXAMPLES

The following example illustrates methods, materials, and results, in accordance with specific embodiments, and as such should not be construed as imposing limitations upon the claims. All components are commercially available from common chemical suppliers, unless otherwise indicated.

In one example system, the thermal interface material 18 was used in a device as shown in FIG. 3. Referring to FIG. 3, the device 30 had a base structure 32 of aluminum, in the form of a plate with rectangular dips (slots) 34 defined at two sides of the structure 32. The slots 34 had a number of pores in the surface (not shown in the figure). In this example, the rectangular shaped slots 34 acted as the first surface 16. The thermal interface material 18 was prepared from an INDALLOY 19® material and made in the shapes of rectangular strips of about 100 μm thickness. After disposing the thermal interface material 18 on the slots of the base structure 32, the second surface 20 made of aluminum and having a surface roughness less than about 16 μm was made to come into contact with the thermal interface material 18, and the system was heated to melt the thermal interface material 18. The liquid thermal interface material 18 partially entered into the pores of the first surface 16 and the interface material 18 remained locked to the first surface 16 after cooling and solidifying. The smooth, second surface 20 did not adhere to the solid thermal interface material 18, and could easily be removed.

During operation, a heat-source 12 was connected to the second surface 20 and a heat-sink 14 was connected to the first surface 16. A pressure of about 100 Psi was applied on the second surface during operation of the system 30. An efficient heat transfer was observed between the heat-source 12 and the heat-sink 14 with the use of liquid thermal material 18. FIG. 4 provides a graphical comparison of the thermal resistivity between different thermal interface materials: the baseline case (no thermal interface material between surface 16 and surface 20), indium metal strip. ARCTIC SILVER 5® paste, and the Low-melt metal alloy (INDALLOY 19®) material. It can be seen from the graph that the thermal resistance is lowest for the low-melt metal alloy thermal interface material 18 described herein. The low-melt metal alloy thermal interface material 18 had about 8 times lower resistance than the baseline case and more than about 2.5 times lower resistance than the solid indium interface. A reduction in the thermal resistance in electronics equipment enhances the maximum allowable power output of the heat-source (such as an electronic device).

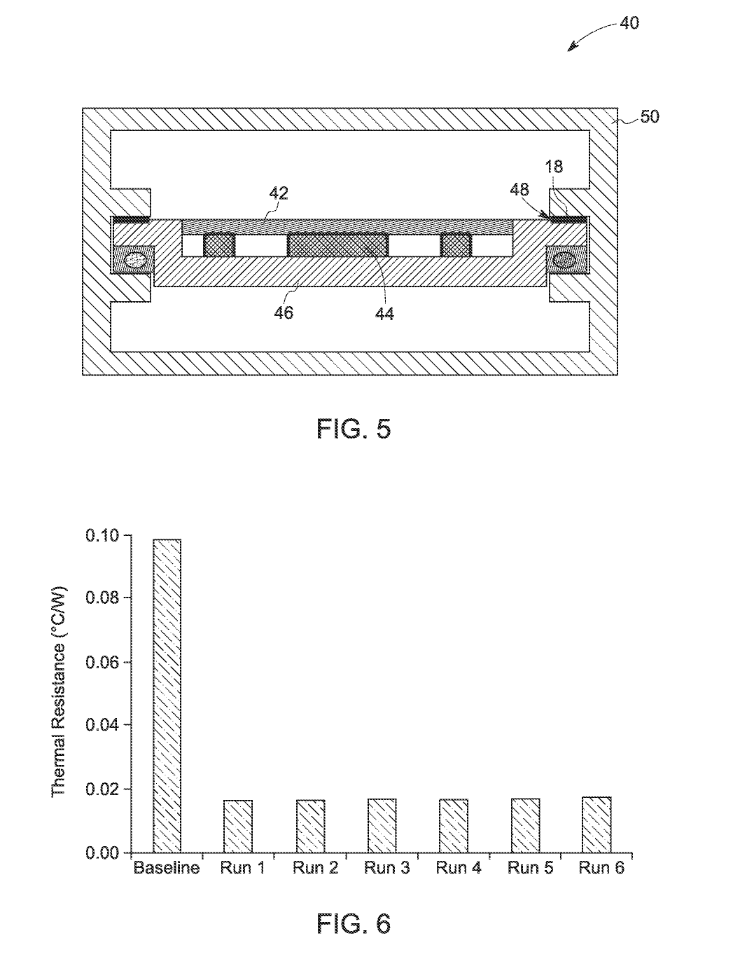

In one example system, the thermal interface material 18 was used to transfer heat in an electronic assembly system 40 from a printed circuit board 42 as shown in FIG. 5. The printed circuit board 42 was coupled to a processor 44 that worked as a heat-source. The processor was coupled to a heat frame 46 that acted as the first surface. The heat frame 46 had a dip 48 that contained the thermal interface material 18 at the point of contact with a chassis 50 acting as a heat sink or as a second surface integrated to the heat sink. In this electronic assembly, the printed circuit board 42, the processor 44, and the heat frame 46 along with the thermal interface material 18 may be easily removed from the chassis 50, thereby facilitating hassle-free removal of the printed circuit board 42 assembly from the chassis 50, when the thermal interface material 18 is in the solid form. When the thermal interface material was in the liquid phase, an effective heat transfer happened between the heat frame 46 and the chassis 50.

FIG. 6 graphically illustrates the advantage of the removable heat-sink of the electronic assembly 40. It can be seen that the thermal resistance across the interface does not significantly increase after multiple assembly/dis-assembly runs, thereby showing the reworkability and reusability of the interface material.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
a first surface;
a second surface; and
an interface material disposed between the first and second surfaces, wherein
the interface material is solid at an assembling temperature and liquid at an operating temperature;
the first surface is configured to adhere to the solid and liquid interface material; and
the second surface is configured to adhere to the liquid interface material and be detachable from the solid interface material.

2. The system of claim 1, wherein the interface material has a thermal conductivity greater than 1 W/mK.

3. The system of claim 1, wherein the assembling temperature is less than about 85° C.

4. The system of claim 3, wherein the assembling temperature is in the range from about 0° C. to about 50° C.

5. The system of claim 1, wherein the operating temperature is greater than about 30° C.

6. The system of claim 5, wherein the operating temperature is in the range from from about 50° C. to about 125° C.

7. The system of claim 1, wherein the interface material comprises indium.

8. The system of claim 7, wherein the interface material further comprises bismuth and tin.

9. The system of claim 8, wherein the interface material comprises indium in the range from about 45 mole % to about 55 mole %, bismuth in the range from about 28 mole % to about 38 mole %, and tin in the range from about 12 mole % to about 22 mole %.

10. The system of claim 9, wherein the interface material comprises indium in the range from about 50 mole % to about 52 mole %, bismuth in the range from about 31 mole % to about 33 mole %, and tin in the range from about 15 mole % to about 17 mole %.

11. The system of claim 1, wherein a thickness of the interface material in between the first and second surfaces during operation is in the range from about 10 microns to about 500 microns.

12. The system of claim 1, wherein the first surface has a surface roughness greater than about 25 μm.

13. The system of claim 1, wherein the first surface comprises a wetting layer.

14. The system of claim 13, wherein the wetting layer comprises a coating material selected from the group consisting of aluminum oxide, nickel, chromium, gold, platinum, and titanium.

15. The system of claim 13, wherein the wetting layer comprises grooves, channels, posts, pillars, or pores.

16. The system of claim 15, wherein at least a part of the interface material is interlocked in the wetting layer at the assembling temperature and at the operating temperatures.

17. The system of claim 1, wherein the second surface has a surface roughness less than about 25 μm.

18. The system of claim 1, wherein the second surface comprises a non-wetting composition for the interface material.

19. The system of claim 1, wherein the interface material experiences a pressure in a range from about 135 kPa (20 psi) to about 3450 kPa (500 psi) at the operating temperature.

20. A system comprising:
a first aluminum surface comprising a wetting layer with pores;
a smooth second aluminum surface; and
a thermal interface material comprising indium in a range from about 50 mole % to about 52 mole %, bismuth in a range from about 31 mole % to about 33 mole %, and tin in a range from about 15 mole % to about 17 mole %, and disposed between the first and second surfaces, wherein
the material is in a solid form at an assembling temperature and in the liquid form at an operating temperature;
a part of the thermal interface material is configured to be interlocked in the wetting layer in the solid and liquid form; and
the second aluminum surface is configured to be detachable from the solid thermal interface material.

21. A method comprising:
disposing a first surface comprising a wetting layer with pores;
disposing an interface material over the first surface;
disposing a second surface over the interface material;
heating the interface material, to a temperature above melting point of the interface material to interlock a part of the interface material within the pores of the wetting layer and to adhere to the first and second surfaces;
cooling the interface material to a temperature below melting point of the interface material to detach the second surface from the interface material; and
removing the second surface from the interface material.
